(19) United States
(12) Patent Application Publication
(10) Pub. No.: US 2002/0112117 A1
(43) Pub. Date: Aug. 15, 2002

(54) Apparatus and method for controlling bank refresh

(76) Inventor: Jung-Won Suh, Kyoungki-do (KR)

Correspondence Address: MARSHALL, GERSTEIN & BORUN, 6300 SEARS TOWER, 233 SOUTH WACKER, CHICAGO, IL, 60606-6357, US

(21) Appl. No.: 10/035,886

(22) Filed: Dec. 26, 2001

(30) Foreign Application Priority Data
Dec. 26, 2000 (KR) 2000-82345

(51) Int. Cl. G06F 12/00

(52) U.S. Cl. 711/106; 711/5

(57) ABSTRACT

Disclosed is an apparatus for controlling a bank refresh including 2^{N} of banks, comprising: N input buffer for buffering N bank address signals inputted from an external circuit with the command signal, a (N-1)-nary counter which is reset by an output signals from the N input buffer, a switch for combining count signals from the (N-1)-nary counter in order to produce internal bank refresh signals in response to external bank address signals from the N buffer and a chipset controller for generating a plurality of internal bank addresses for the refresh using the internal bank refresh signals.

### FIELD OF THE INVENTION

The present invention relates to an apparatus and method for controlling bank refresh.

### DESCRIPTION OF THE PRIOR ART

Generally, data is stored as an electric charge form in a cell capacitor of a memory device. However, such stored data is destroyed continuously by the leakage current because of the characteristic of the capacitor. Therefore, the refresh to recover cell data is required before the complete loss of data in the cell, particularly in dynamic random access memory devices.

In general tendency of the specification of memory devices, the refresh operation is increased and the refresh interval is gradually decreased because the integration and the operation speed of the memory devices is increased.

The refresh time in the entire operation time is increased as the refresh operation is required much more in the highly integrated memory devices and the overload caused by the refresh is frequently generated. Therefore, the research for counterplans to reduce such overloads is actively progressed lately.

In the refresh method of synchronous DRAMs having a plurality of banks, all the banks for the refresh operation are in a standby state at the same time. However, other operations cannot be done during the refresh in this method so that the speed is decreased and the performance of the entire system is deteriorated. One of the solutions to solve this problem is a hidden refresh method. The hidden refresh method, for example, is a method that, in a memory device having eight banks, the six banks are in a normal operation while the two banks are in the refresh operation.

FIG. 1 is a flow chart of the hidden refresh in a synchronous memory device having eight banks.

In FIG. 1, bank 0 and bank 1 are in the hidden refresh operation while other banks perform a read or write operation. Similarly, bank 2 and bank 3 are in the hidden refresh operation while other banks are in normal read or write operation, thereby to reduce the overload in the refresh. However, the addresses for the refresh banks have to be designated and inputted separately with the refresh commands in the hidden refresh method.

As mentioned above, it is troublesome that all banks operate the refresh at once or the refresh bank addresses have to be designated and inputted separately with the refresh commands. Furthermore, these banks are always refreshed in the same sequence because the sequence of the bank refresh is predetermined so that the refresh cannot be completed fluidly.

### SUMMARY OF THE INVENTION

It is, therefore, an object of the present invention to provide an apparatus and method for reducing a refresh load with a high-speed operation in highly integrated memory devices.

In accordance with an aspect of the present invention, there is provide an apparatus for controlling a bank refresh including a plurality of banks, comprising: a plurality of input buffer means for buffering bank address signals inputted from an external circuit with the command signal; a plurality of counter for producing count signals, being reset by an output signals from the N input buffer means; a switch means for combining the count signals from the counter in order to produce internal bank refresh signals in response to bank address signals from the N buffer means; and a chipset control means for generating a plurality of internal bank addresses for the refresh using the internal bank refresh signals.

In accordance with another aspect of the present invention, there is provide a method for controlling a bank refresh including 2^{N} of banks, comprising the steps of: buffering N bank address signals inputted from the external circuit with the refresh command signals; outputting the (N-1)-nary count signal in sequence by resetting at least one of N buffered signals; switching and outputting unit of N-1 count signals to the bank refresh combination signals in response to the N buffered signals; and generating an internal bank address for the refresh using the bank refresh combination signals.

### BRIEF DESCRIPTION OF THE DRAWINGS

The above and other objects and features of the instant invention will become apparent from the following description of preferred embodiments taken in conjunction with the accompanying drawings, in which:

FIG. 1 is a flow chart of the hidden refresh procedure in a synchronous memory device having eight banks in accordance with the prior art;

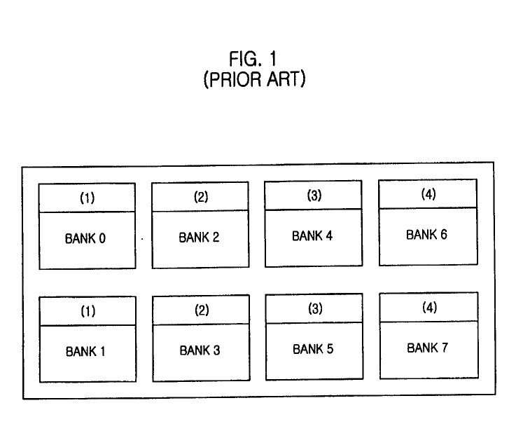

FIG. 2 is a block diagram of a bank refresh controller in accordance with the present invention; and

FIG. 3 is a diagram of three types of bank combination cases for the hidden refresh operation in accordance with the present invention.

### DETAILED DESCRIPTION OF THE PREFERRED EMBODIMENTS

Hereinafter, a controlling bank refresh according to the present invention will be described in detail referring to the accompanying drawings.

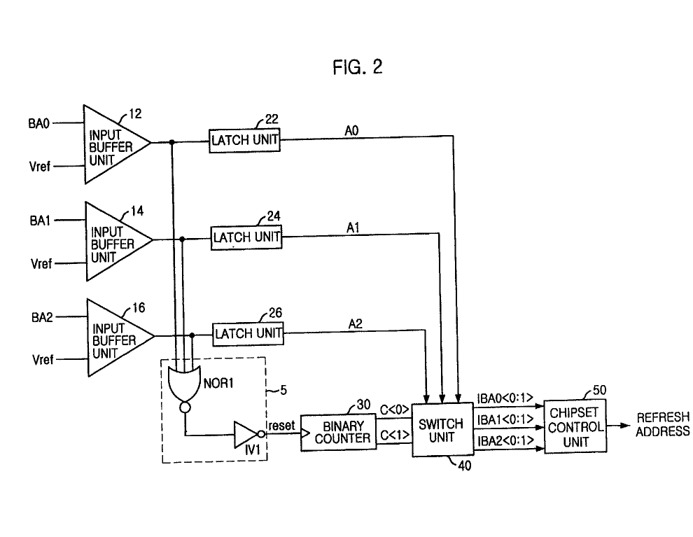

FIG. 2 is a block diagram of a bank refresh controller in accordance with the present invention.

In FIG. 2, the bank refresh controller includes input buffer units 12, 14 and 16 for buffering and outputting three bank address signals inputted from an external circuit in a proper signal level, latch units 22, 24 and 26 for latching output signals from the input buffer units 12, 14 and 16 within a certain period of time only when refresh command signals are applied, a binary counter 30 which is reset by a reset signal from a reset control unit 5, a switch unit 40 for selectively outputting an output signal from the binary counter 30 as a refresh bank combined signal IBA0, IBA1 or IBA2 in response to output signals A0 to A2 of the latch units 22, 24 and 26, and a chipset control unit 50 for outputting a final refresh bank address by processing output signals of the switch unit 40.

The reset control unit 5 includes a 3-input NOR gate NORI for combining the output signals of the three input buffer units 12, 14 and 16 and an inverter IV1 for inverting an output signal from the NOR gate.

However, N means the number of bit, which is used in the bank refresh controller. In the present invention, the number of N is 3 because the number of bit is 3 for combining eight bank addresses. However, the number of bit may vary depending on the number of banks in the memory devices.

In case of the synchronous DRAM having 16 banks, the number N of the input buffer units and the latch units becomes 4. Furthermore, the number N of the synchronous DRAM having 32 banks becomes 5. Because 2^{N} banks have N-1 bit counters 8 banks includes the binary counter.

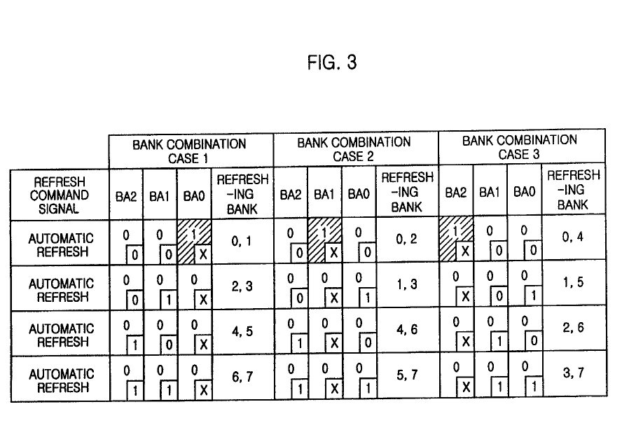

FIG. 3 is a diagram of three types of bank combination cases for the hidden refresh operation.

In FIG. 3, three types of combination cases are shown in response to three bank address signals BA0, BA1 and BA2 inputted from the external circuit with the refresh commands. The ‘O’s and ‘1’s in the shaded boxes mean that the new reset signals are inputted to the binary counter. The values in the small boxes are internal bank address signals IBA0<0:1>, IBA1<0:1>and IBA2<0:1> outputted from the switch unit 40. The ‘X’ means “don't care”.

Three bank address signals BA0, BA1 and BA2 inputted from the external circuit are compared with a reference voltage signal and buffered and outputted to proper signal levels by three input buffer units 12, 14 and 16 with the refresh commands. Each of bank address signals BA0, BA1 and BA2 from three input buffer units 12, 14 and 16 is latched respectively by three latch units 22, 24 and 26 when the refresh signals are applied.

Each of bank address signals BA0, BA1 and BA2 from three input buffers 12, 14 and 16 is logically added up and used as a reset signal from the binary counter 30. That is, if one of the bank address signals BA0, BA1 and BA2 is ‘high’, the binary counter is reset and it starts counting. Furthermore, the output signals C<0> and C<1> of the binary counter 30 are selectively switched and outputted by the switch unit 40 in response to the bank address signals A0, A1 and A2 inputted respectively from three latch units 22, 24 and 26.

The final refresh bank address is outputted from the internal bank combined signals IBA0<0:1>, IBA1<0:1> and IBA2<0:1> in the chipset control unit 50.

In the bank combination case 1, if the bank address signal BA0is inputted in logic ‘high’ with the refresh commands and the bank address signals BA1 and BA2 are inputted in logic ‘low’, the reset signal is outputted to the binary counter 30 by the reset control unit 5. The output signals C<0> and C<1> are outputted in sequence from 0 by the binary counter having the reset signal. At the same time, logic ‘high’, logic ‘low’ and logic ‘low’ outputted from each of bank address signals BA0, BA1 and BA2 are latched respectively in the latch units 22, 24 and 26.

The internal bank address signal IBA0 is changed to ‘X’ state by the switch unit 40 in response to the latched output signals A0, A1 and A2 and the output signals C<0> and C<1> of the binary counter 30 are connected to each of internal bank combined signals IBA1<0:1> and IBA2<0:1>.

Finally, the output signal from the switch unit 40 is inputted and the address, which refreshes the bank 0 and 1, is outputted by the chipset control unit 50. The bank 2 through bank 7 is refreshed in sequence by the counting values from the binary counter after that. However, the input value of all bank addresses BA0, BA1 and BA2 is logic ‘low’.

The completed bank combination is sustained and the hidden refresh operation is repeated in sequence unless other reset signals are applied. The binary counter 30 is reset and refreshed to the new bank combination when three bank address signals BA0, BA1 and BA2 are inputted.

For example, the bank combination is refreshed in sequence by the bank combination case 2 when the bank address signal BA1 is inputted in logic ‘high’ and the bank address signals BA0 and BA2 are inputted in logic ‘low’. The bank combination can be varied depending on the memory system so that the performance of the entire memory system can be improved.

In the present invention, the refresh controller having eight banks is described. However, the synchronous DRAM having 4, 16 or 32 banks can be applied with the present invention. Furthermore, the reset signal from the binary counter 30 can be changed to 2-bit so that the simultaneous hidden refresh operation for four banks can be possible. The address signal combinations other than the bank address signals can be used for the reset signal.

In the present invention, the bank combination for the refresh can be controlled easily so that the performance of the entire memory system can be enhanced.

While the present invention has been described with respect to the particular embodiments, it will be apparent to those skilled in the art that various changes and modifications may be made without departing from the spirit and scope of the invention as defined in the following claims.

What is claimed is:

1. An apparatus for controlling a bank refresh including a plurality of banks, comprising:
a plurality of input buffer means for buffering bank address signals inputted from an external circuit with the command signal;
a counter for producing count signals, being reset by an output signals from the N input buffer means;
a switch means for combining the count signals from the counter in order to produce internal bank refresh signals in response to bank address signals from the N buffer means; and
a chipset control means for generating a plurality of internal bank addresses for the refresh using the internal bank refresh signals.

2. The apparatus as recited in claim 1, wherein the number of the plurality of banks is 2^{N}, the number of the plurality of input buffer means is N and the counter is (N-1)-nary.

3. The apparatus as recited in claim 2, wherein the N input buffer means includes a latch means for sustaining the output signals of the N input buffer means within a certain period of time only when the refresh command signals are applied.

4. The apparatus as recited in claim 2, wherein the (N-1)-nary counter is reset by a logic combination of the bank address signals.

5. A method for controlling a bank refresh including 2^{N} of banks, comprising the steps of:
a) buffering N bank address signals inputted from the external circuit with the refresh command signals;
b) outputting the (N-1)-nary count signal in sequence by resetting at least one of N buffered signals;
c) switching and outputting unit of N-1 count signals to the bank refresh combination signals in response to the N buffered signals; and
d) generating an internal bank address for the refresh using the bank refresh combination signals.
